(19) United States
(12) Patent Application Publication
(10) Pub. No.: US 2014/0119788 A1
(43) Pub. Date: May 1, 2014

(54) FUSING DEVICE AND IMAGE FORMING APPARATUS HAVING THE SAME

(71) Applicant: Samsung Electronics Co., Ltd., Suwon-si (KR)

(72) Inventors: Sun Hyung LEE, Suwon-si (KR); Dong Woo Lee, Suwon-si (KR); Takashi Kidokoro, Suwon-si (KR); Soo Hwan Bae, Seoul (KR)

(73) Assignee: Samsung Electronics Co., Ltd., Suwon-si (KR)

(21) Appl. No.: 14/065,861

(22) Filed: Oct. 29, 2013

(30) Foreign Application Priority Data
Oct. 30, 2012 (KR) 10-2012-0121482

(51) Int. Cl. G03G 15/20

(52) U.S. Cl. CPC G03G 15/2085
USPC 399/329; 399/333

(57) ABSTRACT

A fusing device having a structure which may improve fusing performance is provided. The fusing device includes a heating roller disposed to contact a surface of the recording medium to transfer heat thereto, an endless belt disposed to rotate together with the heating roller, and a pressing member to press an inner surface of the endless belt to allow a fusing nip to be formed between the heating roller and the endless belt.

The heating roller includes a shaft formed in a cylindrical shape, a heat-generating layer disposed to surround the shaft and to generate heat to heat the recording medium passing through the fusing nip, an insulating layer disposed between the shaft and the heat-generating layer to electrically insulate the heat-generating layer and the shaft, and a release layer disposed to surround the heat-generating layer and adapted to prevent the recording medium passing through the fusing nip from sticking to the heating roller.

### CROSS-REFERENCE TO RELATED APPLICATIONS

This application claims the priority benefit of Korean Patent Application No. 2012-0121482, filed on Oct. 30, 2012 in the Korean Intellectual Property Office, the disclosure of which is incorporated herein by reference.

### BACKGROUND

1. Field

Embodiments relate to a fusing device to fix an image to a recording medium and an image forming apparatus having the same.

2. Description of the Related Art

An image forming apparatus is an apparatus to print an image onto a recording medium. Examples of such an image forming apparatus include a printer, a copier, a facsimile machine, and a multifunction device combining functions of the above-mentioned appliances.

In an image forming apparatus adopting electrophotography, an electrostatic latent image is first formed on the surface of a photosensitive body charged with a predetermined electric potential by emitting light onto the photosensitive body, and then a developing agent is supplied onto the electrostatic latent image to form a visible image. The visible image formed on the photosensitive body is transferred to a recording medium. The visible image transferred to the recording medium is fixed to the recording medium as the recording medium passes through the fusing device.

The fusing device generally includes a heating unit to heat a recording medium, and a pressing unit to closely contact the heating unit to form a fusing nip. When the recording medium having an image transferred thereto enters the fusing nip between the heating unit and the pressing unit, an image is fixed to the recording medium by heat and pressure applied by the fusing nip.

There are several techniques that are widely used to heat the heating unit of the fusing device. Examples of the techniques are heating of the heating unit with heat produced by a heat source such as a halogen lamp disposed in a cylindrical rotating shaft, and inductive heating of the surface of the heating unit using heat produced by an inductor disposed outside the heating unit.

However, heating the heating unit using a heat source may cause heat loss since heat produced by the heat source is transferred to the heating unit via air. In addition, since the heat source includes visible light, which does not contribute to heating, rather than infrared light which contributes to heating, heating efficiency may be lowered. In the case of induction heating, a separate space may be necessary to dispose the inductor outside the heating unit, and it may be difficult to directly heat the portions around the fusing nip due to the structure of the inductor.

### SUMMARY

In an aspect of one or more embodiments, there is provided a fusing device having a structure which may improve fusing performance and an image forming apparatus having the same.

In an aspect of one or more embodiments, there is provided a fusing device for an image forming apparatus configured to apply heat and pressure to a recording medium passing through a fusing nip, includes a heating roller disposed to contact a surface of the recording medium to transfer heat thereto, an endless belt disposed to rotate together with the heating roller, and a pressing member to press an inner surface of the endless belt to allow the fusing nip to be formed between the heating roller and the endless belt, wherein the heating roller includes a shaft formed in a cylindrical shape, a heat-generating layer disposed to surround the shaft and to generate heat to heat the recording medium passing through the fusing nip, an insulating layer disposed between the shaft and the heat-generating layer to electrically insulate the heat-generating layer and the shaft, and a release layer disposed to surround the heat-generating layer and adapted to prevent the recording medium passing through the fusing nip from sticking to the heating roller.

The heat-generating layer may include a conductive carbon material.

The carbon material may include at least one of carbon fiber, graphite, carbon black, fullerene, carbon nanotube, cup-stacked carbon nanotube, and carbon nanocoil.

The heat-generating layer may include a resin compound exhibiting resistance to heat.

The resin compound may be polyimide.

The heat-generating layer may include a rubber compound exhibiting resistance to heat.

The rubber compound may be one of silicone rubber and fluorine rubber.

The heat-generating layer may include a conductive metal particle, and a resin compound exhibiting resistance to heat.

The conductive metal particle may include at least one of platinum (Pt), silver (Ag), copper (Cu) and nickel (Ni).

The insulating layer may include a polyimide resin compound.

The heating roller may further include an insulating elastic layer having elasticity to form the fusing nip when the endless belt is pressed by the pressing member.

The insulating elastic layer may include a thermoplastic elastomer.

A thickness of the insulating elastic layer may be less than a thickness of the insulating layer in a radial direction of the heating roller.

The heating roller may further include an electrode connected to both ends of the heat-generating layer to apply electrical power to the heat-generating layer.

At least one portion of the electrode may be disposed between the heat-generating layer and the insulating layer.

At least one portion of the electrode may be disposed between the heat-generating layer and the insulating elastic layer.

The endless belt may be rotated by rotational power transferred thereto from the heating roller.

In an aspect of one or more embodiments, there is provided an image forming apparatus including a fusing device configured to apply heat and pressure to a recording medium passing through a fusing nip to fix an unfused image to the recording medium, wherein the fusing device includes a heating member rotatably disposed, a belt member disposed to be pressed to contact an outer surface of the heating member; and a pressing member to press an inner surface of the endless belt to allow the fusing nip to be formed between the heating roller and the belt, wherein the heating member includes a shaft, a heat-generating layer to generate heat to heat the recording medium passing through the fusing nip, an insulating layer disposed between the shaft and the heat-generating layer to electrically insulate the heat-generating layer and the shaft, and a release layer disposed to surround the shaft and adapted to prevent the recording medium passing through the fusing nip from sticking to the heating member.

The heat-generating layer may be disposed at an outer side of the shaft.

The heat-generating layer may be disposed at an inner side of the shaft.

The heat-generating layer may include one of a resin compound containing a carbon material and a rubber compound containing the carbon material.

The carbon material may include at least one of carbon fiber, graphite, carbon black, fullerene, carbon nanotube, cup-stacked carbon nanotube, and carbon nanocoil.

The heat-generating layer may include a resin compound containing a metal particle.

The metal particle may include at least one of platinum (Pt), silver (Ag), copper (Cu) and nickel (Ni).

The heating member may include an insulating elastic layer disposed between the heat-generating layer and the release layer.

A thickness of the insulating elastic layer may be less than a thickness of the insulating layer.

The insulating layer may include a polyimide resin compound.

The release layer may include a fluorine-based resin.

In an aspect of one or more embodiments, there is provided a fusing device for an image forming apparatus configured to apply heat and pressure to a recording medium passing through a fusing nip, the fusing device including a heating member rotatably disposed; a belt member disposed to be pressed to contact an outer surface of the heating member; and a pressing member to press an inner surface of the endless belt to allow the fusing nip to be formed between the heating roller and the belt, wherein the heating member includes: a shaft; a heat-generating layer to generate heat to heat the recording medium passing through the fusing nip; an insulating layer disposed between the shaft and the heat-generating layer to electrically insulate the heat-generating layer and the shaft; and a release layer disposed to surround the shaft and adapted to prevent the recording medium passing through the fusing nip from sticking to the heating member.

In an aspect of one or more embodiments, there is provided an image forming apparatus including a fusing device configured to apply heat and pressure to a recording medium passing through a fusing nip to fix an unfused image to the recording medium, wherein the fusing device includes a heating roller disposed to contact a surface of the recording medium to transfer heat thereto; an endless belt disposed to rotate together with the heating roller; and a pressing member to press an inner surface of the endless belt to allow the fusing nip to be formed between the heating roller and the endless belt, wherein the heating roller comprises: a shaft formed in a cylindrical shape; a heat-generating layer disposed to surround the shaft and to generate heat to heat the recording medium passing through the fusing nip; an insulating layer disposed between the shaft and the heat-generating layer to electrically insulate the heat-generating layer and the shaft; and a release layer disposed to surround the heat-generating layer and adapted to prevent the recording medium passing through the fusing nip from sticking to the heating roller.

### BRIEF DESCRIPTION OF THE DRAWINGS

These and/or other aspects will become apparent and more readily appreciated from the following description of embodiments, taken in conjunction with the accompanying drawings of which:

FIG. 1 is a view showing the configuration of an image forming apparatus according to an exemplary embodiment;

FIG. 2 is a lateral cross-sectional view showing main constituents of a fusing device according to an exemplary embodiment;

FIGS. 3A and 3B are longitudinal cross-sectional views showing main constituents of the fusing device according to an exemplary embodiment;

FIG. 4 is an enlarged view showing portion A in FIG. 2; and

FIGS. 5 and 6 are views showing a fusing device according to exemplary embodiments.

### DETAILED DESCRIPTION

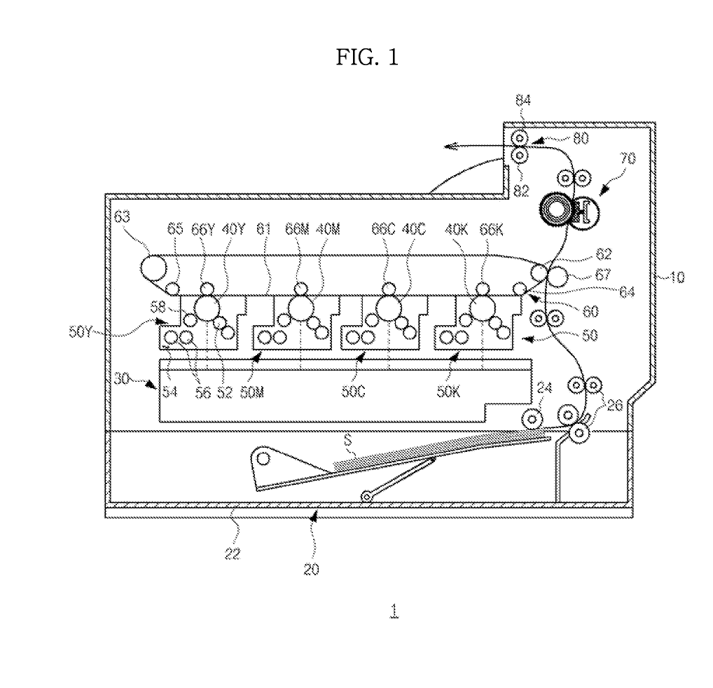

Reference will now be made in detail to embodiments, examples of which are illustrated in the accompanying drawings, wherein like reference numerals refer to like elements throughout. FIG. 1 is a view showing the configuration of an image forming apparatus according to an exemplary embodiment.

As shown in FIG. 1, the image forming apparatus 1 includes a body 10, a recording medium feeding unit 20, an optical scanner 30, a plurality of photosensitive bodies 40Y, 40M, 40C and 40K, a developing device (developer) 50, a transfer unit 60, a fusing device 70, and a recording medium discharging unit 80.

The body 10 forms an external appearance of the image forming apparatus 1 and supports various components installed therein. A portion of the body 10 may be openable. The opened portion of the body 10 allows a user to replace or repair components or to remove a recording medium stuck in the body 10 therethrough.

The recording medium feeding unit 20 feeds recording media S toward the optical scanner 30. The recording medium feeding unit 20 includes a cassette 22 to store the recording media S, a pickup roller 24 to pick up the recording media S stored in the cassette 22 one by one, and transport rollers 26 to transport a recording medium having been picked up toward the transfer unit 60.

The optical scanner 30 forms an electrostatic latent image on the surfaces of the photosensitive bodies 40Y, 40M, 40C and 40K by irradiating the photosensitive bodies 40Y, 40M, 40C and 40K with light corresponding to image information. Although not shown in FIG. 1, the optical scanner 30 may include a light source to emit a light beam, a light deflector to deflect a light beam emitted from a polygonal mirror rotated by a motor, and an F-theta lens to focus the deflected light beam onto the photosensitive bodies.

The developing device 50 forms a visible image by supplying developing agents to the electrostatic latent images formed on the photosensitive bodies 40Y, 40M, 40C and 40K. The developing device 50 may include four developing units 50Y, 50M, 50C and 50K in which developing agents of different colors, e.g., black (K), cyan (C), magenta (M) and yellow (Y), are respectively contained.

Each of the developing units 50Y, 50M, 50C and 50K is provided with a charger 52, a developing agent storage unit 54, a developing agent transport member 56, and a developing member. Before electrostatic latent images are formed on the photosensitive bodies 40Y, 40M, 40C and 40K, each charger 52 charges the surface of a corresponding one of the photosensitive bodies 40Y, 40M, 40C and 40K. The developing agent stored in the developing agent storage unit 54 is transported to the developing member 58 by the developing agent transport member 56, while the developing member 58 supplies the developing agent to the electrostatic latent image formed on the photosensitive body 40Y, 40M, 40C, 40K to form a visible image.

While the four photosensitive body 40Y, 40M, 40C, 40K are illustrated in FIG. 1 as being respectively included in the developing units 50Y, 50M, 50C and 50K, four developing units may alternatively be configured to form a visible image on one photo sensitive body.

The transfer unit 60 receives visible images formed on the photosensitive bodies 40Y, 40M, 40C and 40K and transfers the same to a recording medium. The transfer unit 60 includes a transfer belt 61, a driving roller 62, a support roller 63, tension rollers 64 and 65, and transfer rollers 66Y, 66M, 66C and 66K.

The transfer belt 61 is rotatably supported by the driving roller 62 and the support roller 63. The driving roller 62 rotates via power transferred from a driving source (not shown)mounted in the body 10. The support roller 63 is disposed at a side opposite to the driving roller 62 to support the inner surface of the transfer belt 61.

The outer circumferential surface of the transfer belt 61 faces the photosensitive bodies 40Y, 40M, 40C and 40K. The transfer rollers 66Y, 66M, 66C and 66K are disposed to respectively correspond to the photosensitive bodies 40Y, 40M, 40C and 40K and to support the inner circumferential surface of the transfer belt 61.

When the image forming apparatus 1 performs operation of color printing, the transfer rollers 66Y, 66M, 66C and 66K are respectively pressed toward the photosensitive bodies 40Y, 40M, 40C and 40K. Then, the visible images formed on the photosensitive bodies 40Y, 40M, 40C and 40K are respectively transferred, by the transfer rollers 66Y, 66M, 66C and 66K, to the transfer belt 61 to overlap each other. The image on the transfer belt 61 is transferred to a recording medium supplied from the recording medium feeding unit 20 and passing between the transfer roller 67 and the transfer belt 61.

When the image forming apparatus 1 performs an operation of printing in gray scale, the transfer roller 66K corresponding to the photosensitive body 40K is pressed toward the photosensitive body 40K, and the other transfer rollers 66Y, 66M and 66C are spaced from the corresponding photosensitive bodies 40Y, 40M and 40C.

The recording medium having passed through the transfer unit 60 enters the fusing device 70. The fusing device 70 is adapted to apply heat and pressure to the recording medium to fix an unfused image on the recording medium to the recording medium.

The recording medium having passed through the fusing device 70 is guided to the recording medium discharging unit 80. The recording medium discharging unit 80 discharges the recording medium from the image forming apparatus. The recording medium discharging unit 80 includes a discharge roller 82, and a discharge backup roller 84 installed to face the discharge roller 82.

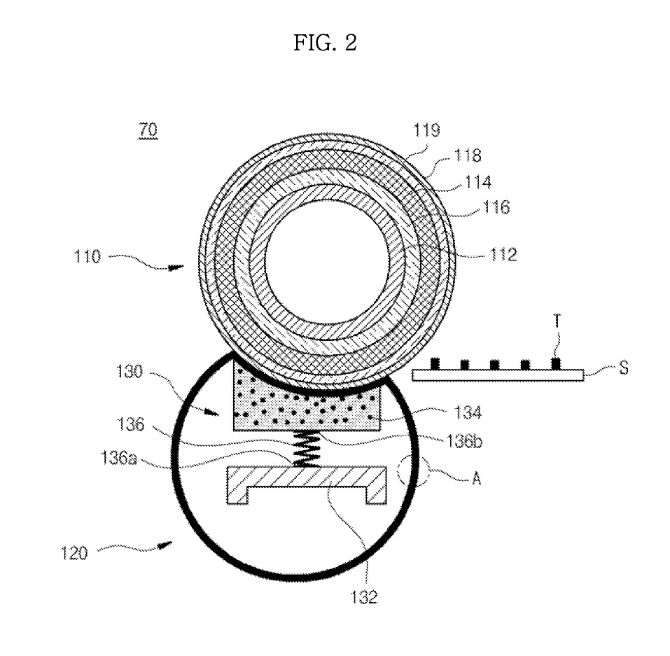

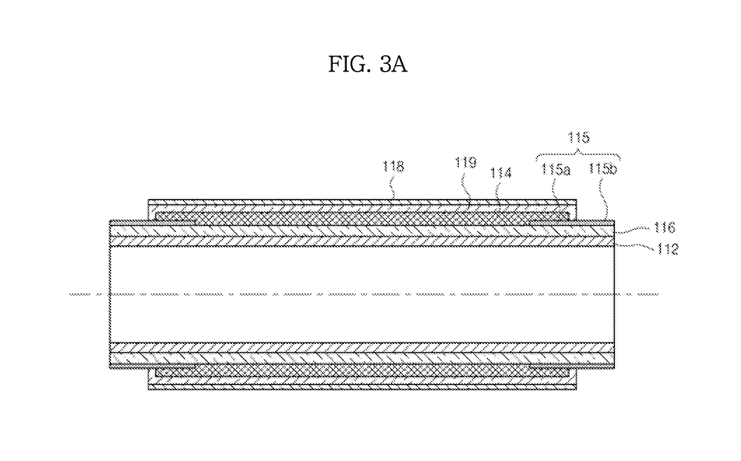

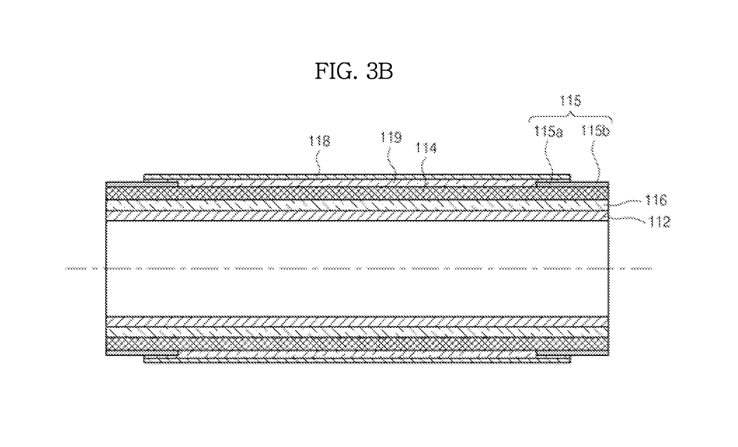

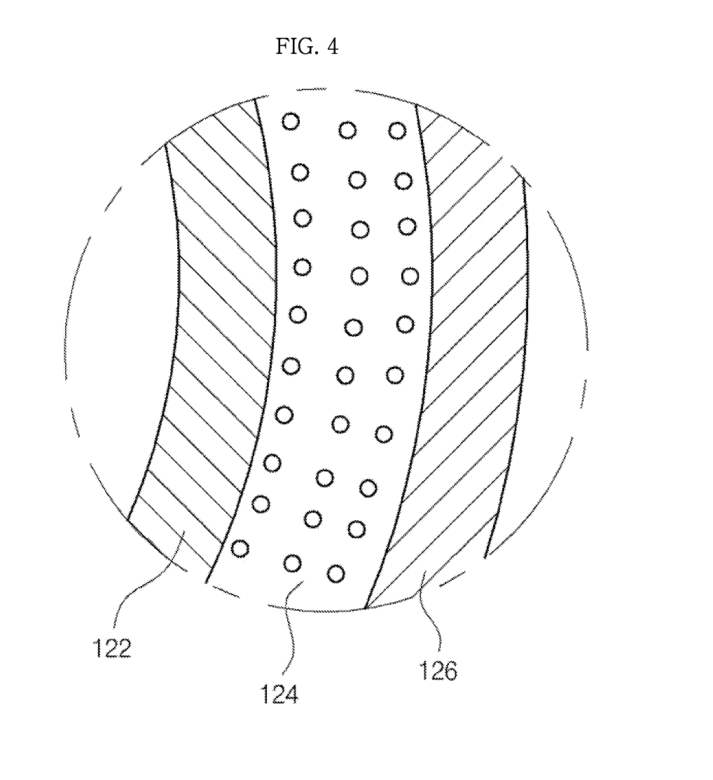

FIG. 2 is a lateral cross-sectional view showing main constituents of a fusing device according to an exemplary embodiment, FIGS. 3A and 3B are longitudinal cross-sectional views showing main constituents of the fusing device according to an illustrated exemplary embodiment, and FIG. 4 is an enlarged view showing portion A in FIG. 2.

As shown in FIGS. 2 to 4, the fusing device 70 includes a heating member 110, a belt member 120 and a pressing member 130. In the description given below, a longitudinal direction X of the fusing device 70 is defined as a direction corresponding to the axial direction of the belt member 120. In addition, the longitudinal direction X of the fusing device 70 may be represented by longitudinal directions of the heating member 110 of the fusing device 70 and a component constituting the heating member 110, e.g., a shaft 112, a heat generating layer 114 or an insulating layer 116.

The heating member 110 and the belt member 120 are disposed to face each other to form a fusing nip N through which a recording medium S passes. The heating member 110 may be arranged to transfer heat to the surface of the recording medium S having an unfused image T formed thereon by contacting the surface. The belt member 120 may be arranged to be pressed against the heating member 110 to rotate together with the heating member 110.

The heating member 110 is disposed to face the belt member 120, and is put into close contact with the belt member 120 at a predetermined pressure to form the fusing nip N. The heating member 110 is rotated by power transmitted thereto from a driving source (not shown) mounted to the body 10 of the image forming apparatus 1. The recording medium S having the unfused image T transferred thereto passes through the fusing nip N between the heating member 110 and the belt member 120. At this time, the unfused image T is fixed to the recording medium S by heat and pressure.

The heating member 110 includes a shaft 112 formed in a cylindrical shape, a heat-generating layer 114 disposed to surround the shaft 112 and to generate heat to heat the recording medium S passing through the fusing nip N, an insulating layer 116 disposed between the shaft 112 and the heat-generating layer 114 to electrically insulate the shaft 112 and the heat-generating layer 114, a release layer 118 to prevent the recording medium S passing through the fusing nip N from sticking to the surface of the heating member 110, and an insulating elastic layer 119 disposed between the heat-generating layer 114 and the release layer 118 and provided with elasticity such that the heating member 110 and the belt member 120 form the fusing nip N therebetween. The insulating elastic layer 119 electrically insulates the heat-generating layer 114 and the release layer 118.

The shaft 112 is disposed at the center of the heating member 110 to function as a rotating shaft and to support the materials stacked thereon. The shaft 112 may be formed of a metallic material such as aluminum or steel.

The heat-generating layer 114 is formed to extend along the longitudinal direction X of the heating member 110. The heat-generating layer 114, which is an electrical resistor adapted to generate heat when current is supplied thereto, may be formed of one of a resin compound having a conductive carbon material dispersed therein, a rubber compound having a carbon material dispersed therein, and a resin compound having metal particles dispersed therein.

In the case of using a conductive carbon material, the material may be one of carbon fiber, graphite, carbon black, fullerene, carbon nanotube, cup-stacked carbon nanotube, and carbon nanocoil, or a combination thereof.

In the case of using metal particles, the metal particles may be one of silver (Ag), platinum (Pt), nickel (Ni) and copper (Cu) particles whose particle diameter is between about 500 nm and about 100 μm, or a combination thereof.

The carbon material or the resin compound having metal particles dispersed therein may be polyimide exhibiting resistance to heat. The rubber compound may be one of fluorine rubber and silicone rubber exhibiting resistance to heat.

Heat generated in the heat-generating layer 114 is directly transferred to the surface of the heating member 110 via the elastic layer 119 and used to fuse the unfused image T on the surface of the recording medium S passing through the fusing nip N.

The thickness of the heat-generating layer 114 may vary depending on concentration of the carbon material or metal particles which are dispersed in the resin compound or the rubber compound. The thickness may be between about 20 μm and about 50 μm.

An electrode 115 to apply voltage to the heat-generating layer 114 is disposed at both ends of the heat-generating layer 114. As shown in FIG. 3, one portion 115a of the electrode 115 is disposed between the heat-generating layer 114 and the insulating layer 116, and the other portion 115b is exposed to the outside. The other portion 115b exposed to the outside is connected to a power supply (not shown). When voltage is applied to the heat-generating layer 114 by the electrode 115, current flows in the heat-generating layer 114 due to the carbon material or metal particles included in the heat-generating layer 114. While current flows, heat to heat the recording medium S is generated.

The one portion 115a of the electrode 115 may be disposed between the heat-generating layer 114 and the insulating elastic layer 119, while the other portion 115b may be exposed to the outside, as shown in FIG. 3B.

The insulating layer 116 is formed to extend along the longitudinal direction X of the heating member 110. The insulating layer 116 is formed of a material having an insulating property to prevent current supplied to the heat-generating layer 114 from flowing into the shaft 112 formed of a metallic material, and a heat resistant property to prevent deformation thereof by heat generated in the heat-generating layer. As a material having both the insulating property and the heat resistant property for the insulating layer 116, a polyimide resin compound may be used.

In consideration of voltage applied to the heat-generating layer 114 by the electrode 115 and the thermal conductivity of the insulating layer 116, the thickness of the insulating layer 116 may be between about 20 μm and about 50 μm.

The insulating elastic layer 119 is formed to extend along the longitudinal direction X of the heating member 110. When pressure is applied to the heating member 110 and the belt member 120 by the pressing member 130, the elastic layer 119 is elastically deformed to allow the fusing nip N to be formed between the heating member 110 and the belt member 120 and to prevent current supplied to the heat-generating layer 114 from flowing to the surface of the heating member 110 or the release layer 118. The insulating elastic layer 119 may be formed of one of various rubber materials such as fluorine rubber, silicone rubber, natural rubber, isoprene rubber, butadiene rubber, nitrile rubber, chloroprene rubber, butyl rubber, acrylic rubber, and urethane rubber which are elastic and insulating, and thermoplastic elastomers such as styrene-based, polyolefin-based, polyvinyl chloride-based, polyurethane-based, polyester-based, polyamide-based, polybutadiene-based, polyethylene-based elastomers, or a combination thereof.

To allow heat generated in the heat-generating layer 114 to be smoothly transferred to the surface of the heating member 110, the insulating elastic layer 119 may be formed to be thinner than the insulating layer 116, and the thickness thereof may be between about 10 μm and about 50 μm.

The release layer 118 may be a tube formed of a fluorine-based resin, such as, for example, perfluoroalkoxy (PFA), polytetrafluoroethylene (PTFE), and fluorinated ethylene propylene (FEP) or coated therewith.

The belt member 120 includes a base layer 122 and an elastic layer 124 surrounding the base layer 122.

The base layer 122 may be formed of a resin compound such as polyimide, polyamide, and polyimide-amide which exhibit resistance to heat, or a metallic material such as aluminum alloys and nickel alloys. The thickness of the base layer 122 may be between about 30 μm and about 200 μm.

Like the insulating elastic layer 119 described above, the elastic layer 124 may be formed of fluorine rubber or silicone rubber.

The surface of the belt member 120 may be coated with a belt release layer 126. The belt release layer 126 prevents the recording medium S passing through the fusing nip N from sticking to the surface of the belt member 120. Like the release layer 118 described above, the belt release layer 126 may be a tube formed of a fluorine resin such as, for example, PFA, PTFE and FEP.

The pressing member 130 is disposed in the belt member 120 to press the inner surface of the belt member 120 toward the heating member 110 to form the fusing nip between the heating member 110 and the belt member 120.

The pressing member 130 includes a support portion 132, a pressing portion 134 to contact the inner surface of the belt member 120, and an elastic portion 136 disposed between the support portion 132 and the pressing portion 134.

One end 136a of the elastic portion 136 is fixed to the support portion 132, and the other end 136b thereof is connected to the pressing portion 134. The other end 136b of the elastic portion 136 elastically supports the pressing portion 134 toward the heating member 110.

One surface of the pressing portion 134 contacting the inner surface of the belt member 120 is formed to have a shape approximately corresponding to the outer surface of the heating member 110. To reduce heat transfer from the heating member 110 to the pressing portion 134, the pressing portion 134 may be formed of a material having a porous structure, which is highly insulating.

As described above, heat generated in the heat-generating layer 114 formed immediately inside the surface of the heating member 110 is directly transferred to the surface of the heating member 110, and therefore the rate of increase in temperature of the heating member 110 is high. That is, the time taken to reach a target temperature at which the unfused image T positioned on the surface of the recording medium S is fused is shortened.

In addition, since most of the heat generated in the heat-generating layer 114 and transferred to the surface of the heating member 110 is used to fuse the unfused image T on the surface of the recording medium S, fusing efficiency is high. Therefore, fusing time may be reduced and print quality may be improved.

Exemplary embodiments of the heating member 110 to improve fusing performance of the fusing device 100 or secure stability thereof will be described.

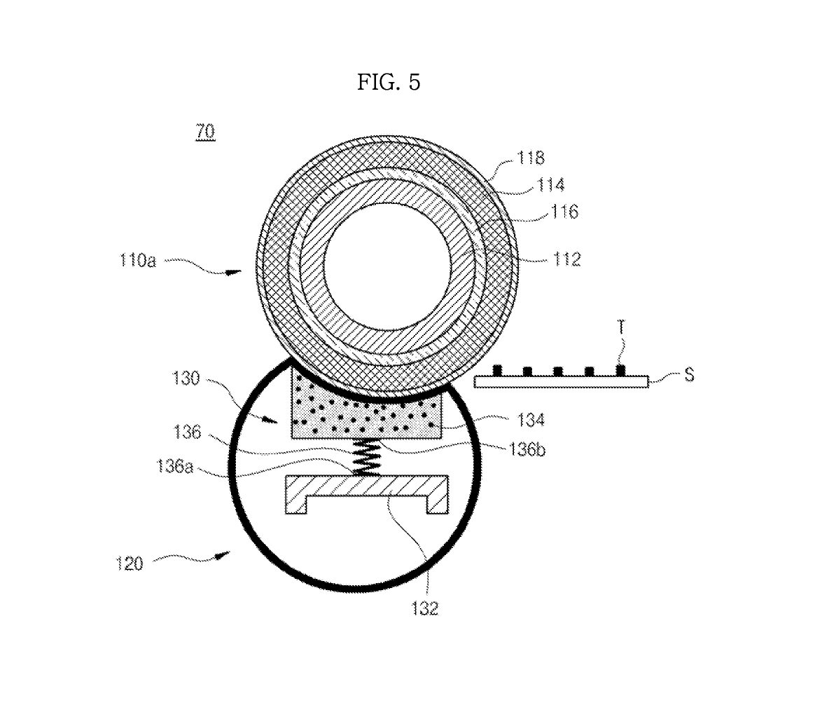

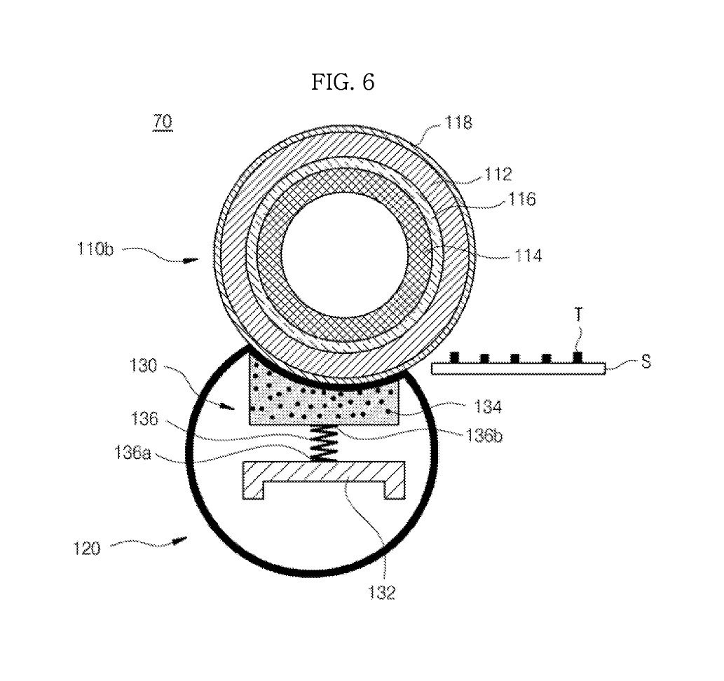

FIGS. 5 and 6 are views showing a fusing device according to exemplary embodiments.

As shown in FIG. 5, a heating member 110a may have a structure in which the release layer 118 surrounds the outer circumferential surface of the heat-generating layer 114, or a structure in which the release layer 118 is directly coated onto the surface of the heat-generating layer 114.

In the structure as above, the path of heat transfer along which heat generated in the heat-generating layer 114 is transferred to the surface of the heating member 110a is short, and therefore the time taken to reach the target temperature at which the unfused image T positioned on the surface of the recording medium S is fused is further shortened. Since the heating member 110a is small in size, a compact design may be realized.

As shown in FIG. 6, a heating member 110b may have a structure in which the heat-generating layer 114 is disposed inside a shaft 112. That is, the heating member 110b includes a cylinder-shaped shaft 112, a heat-generating layer 114 disposed along the inner circumferential surface of the shaft 112, an insulating layer 116 disposed between the inner circumferential surface of the shaft 112 and the heat-generating layer 114, and a release layer 118 disposed on the outer circumferential surface of the shaft 112.

In the case of the structure as above, since the heat-generating layer 114 to which voltage is applied is disposed inside the shaft 112, accidents such as electric shock and fire due to contact with the heating member 110b may be prevented.

As is apparent from the above description, a heat-generating member is formed in layers surrounding the inner side or outer side of the shaft of a heating roller, and thereby the surface of the heating roller may be directly heated. Accordingly, high heating efficiency may be obtained and the heating roller may be heated to a high temperature in a short time.

In addition, since uniform temperature distribution is realized on the surface of the heating roller, toner may be stably fused to a recording medium and therefore print quality may be improved.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed:

1. A fusing device for an image forming apparatus configured to apply heat and pressure to a recording medium passing through a fusing nip, the fusing device comprising:
a heating roller disposed to contact a surface of the recording medium to transfer heat thereto;
an endless belt disposed to rotate together with the heating roller; and
a pressing member to press an inner surface of the endless belt to allow the fusing nip to be formed between the heating roller and the endless belt,
wherein the heating roller comprises:
a shaft formed in a cylindrical shape;
a heat-generating layer disposed to surround the shaft and to generate heat to heat the recording medium passing through the fusing nip;
an insulating layer disposed between the shaft and the heat-generating layer to electrically insulate the heat-generating layer and the shaft; and
a release layer disposed to surround the heat-generating layer and adapted to prevent the recording medium passing through the fusing nip from sticking to the heating roller.

2. The fusing device according to claim 1, wherein the heat-generating layer includes a conductive carbon material.

3. The fusing device according to claim 2, wherein the carbon material includes at least one of carbon fiber, graphite, carbon black, fullerene, carbon nanotube, cup-stacked carbon nanotube, and carbon nanocoil.

4. The fusing device according to claim 2, wherein the heat-generating layer includes a resin compound exhibiting resistance to heat.

5. The fusing device according to claim 4, wherein the resin compound is polyimide.

6. The fusing device according to claim 2, wherein the heat-generating layer includes a rubber compound exhibiting resistance to heat.

7. The fusing device according to claim 6, wherein the rubber compound is one of silicone rubber and fluorine rubber.

8. The fusing device according to claim 1, wherein the heat-generating layer includes:
a conductive metal particle; and
a resin compound exhibiting resistance to heat.

9. The fusing device according to claim 8, wherein the conductive metal particle includes at least one of platinum (Pt), silver (Ag), copper (Cu) and nickel (Ni).

10. The fusing device according to claim 1, wherein the insulating layer includes a polyimide resin compound.

11. The fusing device according to claim 1, wherein the heating roller further comprises an insulating elastic layer having elasticity to form the fusing nip when the endless belt is pressed by the pressing member.

12. The fusing device according to claim 11, wherein the insulating elastic layer includes a thermoplastic elastomer.

13. The fusing device according to claim 11, wherein a thickness of the insulating elastic layer is less than a thickness of the insulating layer in a radial direction of the heating roller.

14. The fusing device according to claim 11, wherein the heating roller further comprises an electrode connected to both ends of the heat-generating layer to apply electrical power to the heat-generating layer.

15. The fusing device according to claim 14, wherein at least one portion of the electrode is disposed between the heat-generating layer and the insulating layer.

16. The fusing device according to claim 14, wherein at least one portion of the electrode is disposed between the heat-generating layer and the insulating elastic layer.

17. The fusing device according to claim 1, wherein the endless belt is rotated by rotational power transferred thereto from the heating roller.

18. An image forming apparatus including a fusing device configured to apply heat and pressure to a recording medium passing through a fusing nip to fix an unfused image to the recording medium,
wherein the fusing device comprises:
a heating member rotatably disposed;
a belt member disposed to be pressed to contact an outer surface of the heating member; and
a pressing member to press an inner surface of the endless belt to allow the fusing nip to be formed between the heating roller and the belt,
wherein the heating member comprises:
a shaft;
a heat-generating layer to generate heat to heat the recording medium passing through the fusing nip;
an insulating layer disposed between the shaft and the heat-generating layer to electrically insulate the heat-generating layer and the shaft; and
a release layer disposed to surround the shaft and adapted to prevent the recording medium passing through the fusing nip from sticking to the heating member.

19. The image forming apparatus according to claim 18, wherein the heat-generating layer is disposed at an outer side of the shaft.

20. The image forming apparatus according to claim 18, wherein the heat-generating layer is disposed at an inner side of the shaft.

21. The image forming apparatus according to claim 18, wherein the heat-generating layer includes one of a resin compound containing a carbon material and a rubber compound containing the carbon material.

22. The image forming apparatus according to claim 21, wherein the carbon material includes at least one of carbon fiber, graphite, carbon black, fullerene, carbon nanotube, cup-stacked carbon nanotube, and carbon nanocoil.

23. The image forming apparatus according to claim 18, wherein the heat-generating layer includes a resin compound containing a metal particle.

24. The image forming apparatus according to claim 23, wherein the metal particle includes at least one of platinum (Pt), silver (Ag), copper (Cu) and nickel (Ni).

25. The image forming apparatus according to claim 19, wherein the heating member further comprises an insulating elastic layer disposed between the heat-generating layer and the release layer.

26. The image forming apparatus according to claim 25, wherein a thickness of the insulating elastic layer is less than a thickness of the insulating layer.

27. The image forming apparatus according to claim 18, wherein the insulating layer includes a polyimide resin compound.

28. The image forming apparatus according to claim 18, wherein the release layer includes a fluorine-based resin.
